(19) United States
(12) Patent Application Publication
(10) Pub. No.: US 2016/0378230 A1
(43) Pub. Date: Dec. 29, 2016

(54) PROTECTIVE MEMBRANE STRUCTURE AND METHOD OF REMOVING MEMBRANE

(71) Applicants: Interface Optoelectronics (ShenZhen) Co., Ltd., Shenzhen (CN); General Interface Solution Limited, Miaoli County (TW)

(72) Inventors: Chen-Ming JEN, Guangdong (CN); Cheng-Feng TSAI, Guangdong (CN)

(21) Appl. No.: 14/883,641

(22) Filed: Oct. 15, 2015

(30) Foreign Application Priority Data
Jun. 25, 2015 (CN) 201510357953.8

(51) Int. Cl. G06F 3/041; B32B 43/00

(52) U.S. Cl. CPC G06F 3/0412; B32B 43/006; G06F 2203/04107; G06F 2203/04103

(57) ABSTRACT

A protective membrane structure is configured to protect a pan& module. The protective membrane structure includes a main body, an adhesive member, and a pulling member. The main body is attached to the panel module. The adhesive member is disposed on the main body. The pulling member is located over the main body and has an adhesive portion and a warping portion connected to each other. The adhesive member is adhered between the main body and the adhesive portion. The warping portion warps away from the main body.

### RELATED APPLICATIONS

This application claims priority to Chinese Application Serial Number 201510357953.8, filed Jun. 25, 2015, which is herein incorporated by reference.

### BACKGROUND

Technical Field

The present disclosure relates to a protective membrane structure and a method of removing membrane, and more particularly, to a protective membrane structure for protecting a panel module and a method of removing membrane.

Description of Related Art

For conventional display panel modules and/or touch panel modules, protective membranes are generally attached onto the display panel modules and/or touch panel modules to avoid damages from transportation or testing processes. The protective membranes are removed from the display panel modules and/or touch panel modules when assembling processes begin. For example, the protective membranes are adhered to pulling taps by adhesive members. While removing the protective membranes, assembly workers pull the pulling taps to separate the protective membranes from the display panel modules and/or touch panel modules.

In general, the thickness of the adhesive members is very small (about 0.05 micrometer) and surfaces of the pulling taps are very glossy. Under the gravity or external forces, the pulling taps tend to closely attach to the surfaces of the protective membranes. In this regard, it becomes more difficult for the assembly workers to remove the protective membranes by the pulling taps due to the close attachment of the pulling taps and the protective membranes.

### SUMMARY

Accordingly, an aspect of the disclosure is to provide a protective membrane structure and a method of removing membrane to solve the above-mentioned problems.

The disclosure provides a protective membrane structure is configured to protect a panel module. The protective membrane structure includes a main body, an adhesive member, and a pulling member. The main body is attached to the panel module. The adhesive member is disposed on the main body. The pulling member is located over the main body and has an adhesive portion and a warping portion connected to each other. The adhesive member is adhered between the main body and the adhesive portion. The warping portion warps away from the main body.

In an embodiment of the disclosure, the warping portion has at least one creasing line, and the creasing line is located on a surface of the warping portion facing away from the main body.

In an embodiment of the disclosure, the warping portion has a plurality of creasing lines, and the creasing lines are arranged along a direction leaving away from the adhesive portion.

In an embodiment of the disclosure, the creasing lines are substantially parallel to each other.

In an embodiment of the disclosure, the creasing lines are arranged in a gradually closer manner along the direction leaving away from the adhesive portion.

In an embodiment of the disclosure, the creasing lines are arranged in a gradually farer manner along the direction leaving away from the adhesive portion.

In an embodiment of the disclosure, the warping portion has at least another creasing line located on a surface of the warping portion facing the main body.

In an embodiment of the disclosure, the adhesive member is a double-sided adhesive.

The disclosure further provides a method of removing membrane for removing a protective membrane structure from a panel module. The protective membrane structure includes a main body, an adhesive member, and a pulling member. The main body is attached to the panel module. The pulling member has a first part and a second part connected to each other. The adhesive member is adhered between the main body and the first part. The method includes: forming at least one creasing line on a surface of the second part facing away from the main body, such that the second part warps away from the main body; and pulling the second part along a direction leaving away from the main body, so as to remove the main body from the panel module.

In an embodiment of the disclosure, the forming of the creasing line includes: forming a plurality of the creasing lines on the second part along a direction leaving away from the first part.

In an embodiment of the disclosure, the creasing lines are substantially parallel to each other.

In an embodiment of the disclosure, the forming of the creasing line comprising: forming the creasing line by scribing the second part with a blunt object.

In an embodiment of the disclosure, the blunt object is a blunt knife.

In an embodiment of the disclosure, the method further includes: forming at least an additional creasing line on a surface of the second part facing the main body.

Accordingly, the protective membrane structure of the disclosure and the method of removing membrane are about forming creasing lines on the surface of the pulling member facing away from the main body, so as to make the part of the pulling member not adhered to the main body warp away from the main body. Therefore, the assembly workers can easily hold the warping pulling member, which facilitates the subsequent step of removing the main body away. Furthermore, the protective membrane structure of the disclosure and the method of removing membrane can achieve the purpose of adjusting the warpage of each portion of the warping portion of the pulling member by adjusting the arrangement (e.g., arranged in an equidistant manner, in a gradually closer manner, or in a gradually closer manner) or locations (e.g., on the upper surface or the lower surface of the warping portion) of the creasing lines.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a top view of a protective membrane structure according to an embodiment of the disclosure;

FIG. 2 is a side view illustrating a protective membrane structure disposed on a panel module according to an embodiment of the disclosure;

FIG. 3 is a side view illustrating a protective membrane structure disposed on a panel module according to another embodiment of the disclosure;

FIG. 4 is a side view illustrating a protective membrane structure disposed on a panel module according to another embodiment of the disclosure;

FIG. 5 is a side view illustrating a protective membrane structure disposed on a panel module according to another embodiment of the disclosure; and

FIG. 6 is flow chart of a method of removing membrane according to an embodiment of the disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

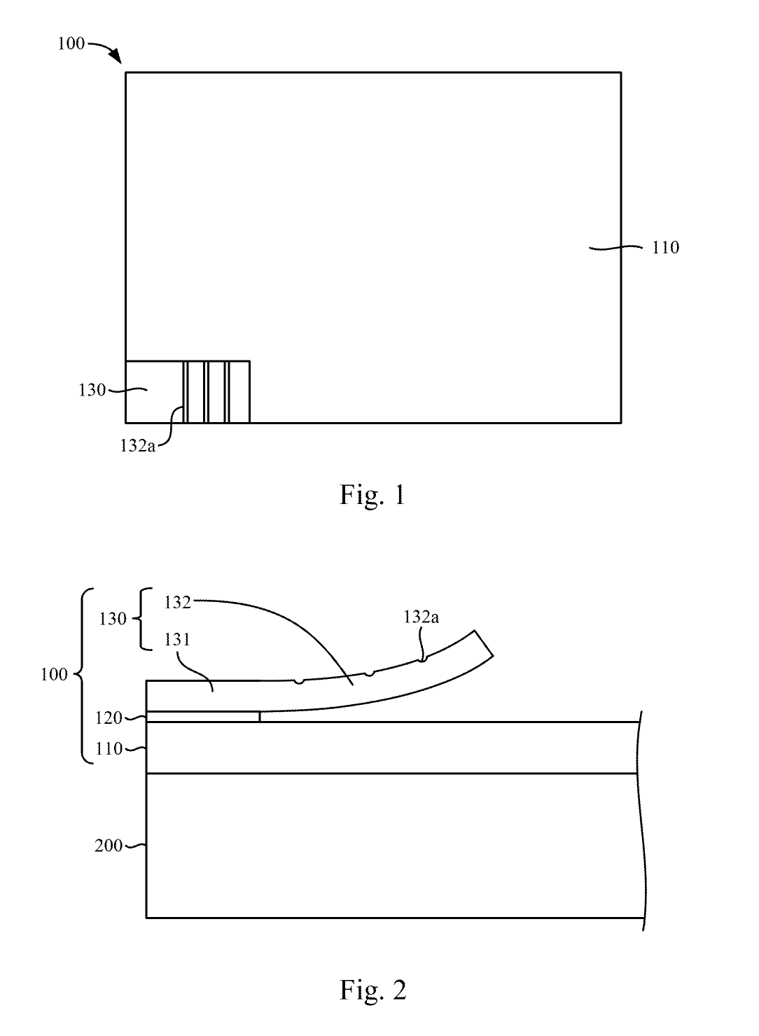

FIG. 1 is a top view of a protective membrane structure 100 according to an embodiment of the disclosure. FIG. 2 is a side view illustrating a protective membrane structure 100 disposed on a panel module 200 according to an embodiment of the disclosure.

As shown in FIG. 1 and FIG. 2, in the embodiment, the protective membrane structure 100 is configured to protect the panel module 200. The protective membrane structure 100 includes a main body 110, an adhesive member 120, and a pulling member 130. The main body 110 is attached to the panel module 200. The adhesive member 120 is disposed on the main body 110. The pulling member 130 is located over the main body 110 and has an adhesive portion 131 and a warping portion 132 connected to each other. The adhesive member 120 is adhered between the main body 110 and the adhesive portion 131. The warping portion 132 warps away from the main body 110. In other words, in the direction leaving away from the adhesive portion 131, distances between the warping portion 132 and the main body 110 gradually increase.

Specifically, the warping portion 132 of the pulling member 130 has a plurality of creasing lines 132a, and the creasing lines 132a are located on a surface of the warping portion 132 facing away from the main body 110. The creasing line 132a are arranged along a direction leaving away from the adhesive portion 131. The warping portion 132 is downwardly creased at the creasing line 132a, so that stress concentrations locally occurred and cause the warpage of the warping portion 132.

In an embodiment of the disclosure, the creasing lines 132a are substantially parallel to each other, but the disclosure is not limited in this regard. In practical applications, the creasing lines 132a can be not parallel, so that the warping direction of the warping portion 132 of the pulling member 130 can be controlled. For example, the warpages of two sides of the pulling member 130 can be controlled to be different, so as to coordinate the operating convenience of assembly workers.

In the embodiment of the disclosure, the warping portion 130 has three creasing lines 132a, but the disclosure is not limited in this regard. In practical applications, the number of the creasing lines 132a on the warping portion 130 can be adjusted with flexibility according to actual requirements. To achieve the purpose of making the warping portion 130 warp, the warping portion 130 can have only one creasing line 132a.

In an embodiment of the disclosure, the adhesive member 120 is a double-sided adhesive, but the disclosure is not limited in this regard. In practical applications, the adhesive member 120 can be any colloid having stickiness.

In an embodiment of the disclosure, the foregoing panel module 200 can be a display panel module or a touch panel module, but the disclosure is not limited in this regard.

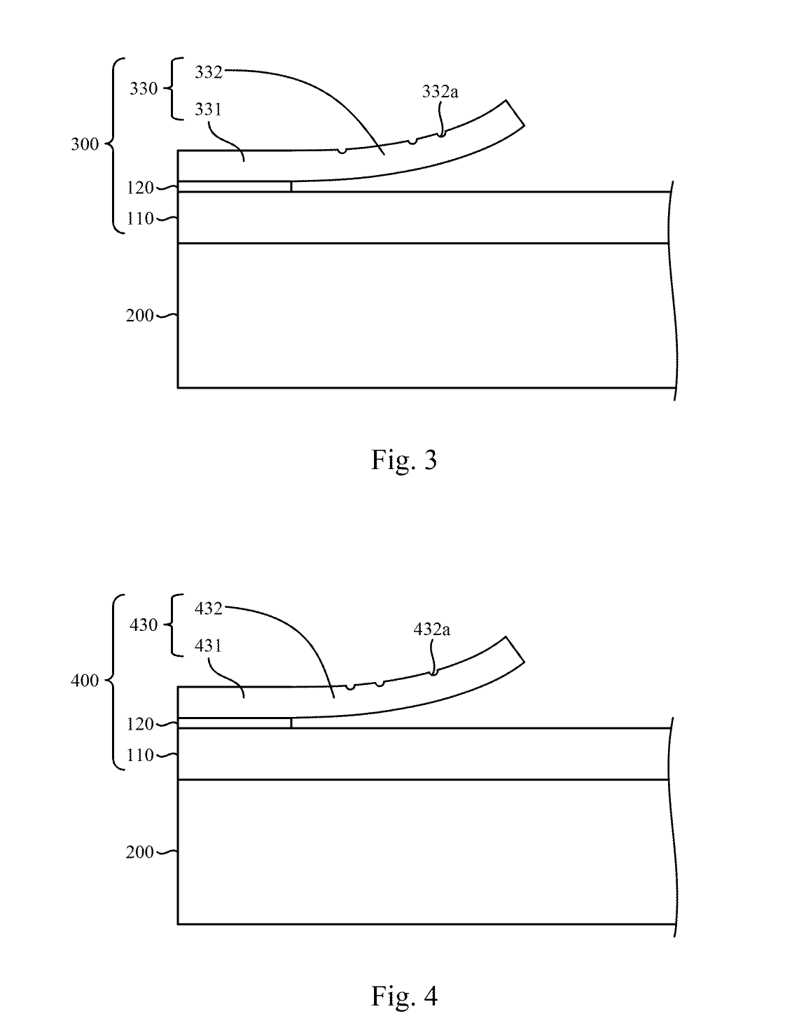

FIG. 3 is a side view illustrating a protective membrane structure 300 disposed on a panel module 200 according to another embodiment of the disclosure. As shown in the figure, in the embodiment, the protective membrane structure 300 includes a main body 110, an adhesive member 120, and a pulling member 330. The main body 110 and the adhesive member 120 are similar to those of the embodiment shown in FIG. 2, so the structures and the functions of these components and the actual connection relationships among the components can be referred to the foregoing descriptions and therefore are not repeated here to avoid duplicity. It should be pointed out that the difference between the protective membrane structure 300 of the present embodiment and the protective membrane structure 100 shown in FIG. 2 is that on the pulling member 330 of the present embodiment, the creasing lines 332a on the warping portion 332 are arranged in a gradually closer manner along the direction leaving away from the adhesive portion 331. That is, in the foregoing direction leaving away from the adhesive portion 331, the distances between two adjacent creasing lines 332a gradually decrease. Therefore, a portion of the warping portion 332 proximal to the adhesive portion 331 has a smaller warpage, and a portion of warping portion 332 distal to the adhesive portion 331 has a larger warpage.

FIG. 4 is a side view illustrating a protective membrane structure 400 disposed on a panel module 200 according to another embodiment of the disclosure. As shown in the figure, in the embodiment, the protective membrane structure 400 includes a main body 110, an adhesive member 120, and a pulling member 430. The main body 110 and the adhesive member 120 are similar to those of the embodiment shown in FIG. 2, so the structures and the functions of these components and the actual connection relationships among the components can be referred to the foregoing descriptions and therefore are not repeated here to avoid duplicity. It should be pointed out that the difference between the protective membrane structure 400 of the present embodiment and the protective membrane structure 100 shown in FIG. 2 is that on the pulling member 430 of the present embodiment, the creasing lines 432a on the warping portion 432 are arranged in a gradually farer manner along the direction leaving away from the adhesive portion 431. That is, in the foregoing direction leaving away from the adhesive portion 431, the distances between two adjacent creasing lines 432a gradually increase. Therefore, a portion of the warping portion 432 proximal to the adhesive portion 431 has a larger warpage, and a portion of warping portion 432 distal to the adhesive portion 431 has a smaller warpage.

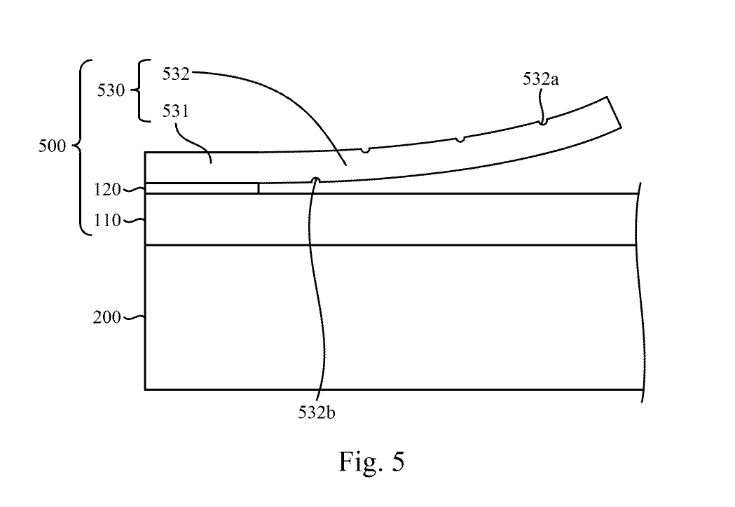

FIG. 5 is a side view illustrating a protective membrane structure 500 disposed on a panel module 200 according to another embodiment of the disclosure. As shown in the figure, in the embodiment, the protective membrane structure 500 includes a main body 110, an adhesive member 120, and a pulling member 530. The main body 110 and the adhesive member 120 are similar to those of the embodiment shown in FIG. 2, so the structures and the functions of these components and the actual connection relationships among the components can be referred to the foregoing descriptions and therefore are not repeated here to avoid duplicity. It should be pointed out that the differences between the protective membrane structure 500 of the present embodiment and the protective membrane structure 100 shown in FIG. 2 are that the whole length of the pulling member 530 of the embodiment is longer (i.e., the length of the warping portion 532 of the pulling member 530 is longer), and that in addition to the creasing lines 532a disposed on the surface of the warping portion 532 facing away from the main body 110 (i.e., the upper surface), the warping portion 532 further has another creasing line 532b disposed on another surface of the warping portion 532 facing the main body 110 (i.e., the lower surface). Therefore, under the circumstances that the whole length of the pulling member 530 is longer, the warpage of the warping portion 532 caused by the creasing lines 532a located on the upper surface of the pulling member 530 can be reduced or compensated by the another creasing line 532b located on the lower surface of the pulling member 530, so as to prevent the warping portion 532 from excessive warping.

In the embodiment of the disclosure, the warping portion 532 has only one of the creasing line 532b, but the disclosure is not limited in this regard. In practical applications, the number of the creasing line 532b on the warping portion 532 can be adjusted with flexibility according to actual requirements. For example, the number of the creasing lines 532b can also be three.

In some embodiments of the disclosure, the warping portion 532 has a plurality of the creasing lines 532b, and the creasing lines 532b can be arranged in an equidistant manner (as the arrangement of the creasing lines 132a shown in FIG. 2), in a gradually closer manner (as the arrangement of the creasing lines 332a shown in FIG. 3), or in a gradually farer manner (as the arrangement of the creasing lines 432a shown in FIG. 4) along the direction leaving away from the adhesive portion 531, so as to similarly achieve the purpose of adjusting the warpage of each portion of the warping portion 532.

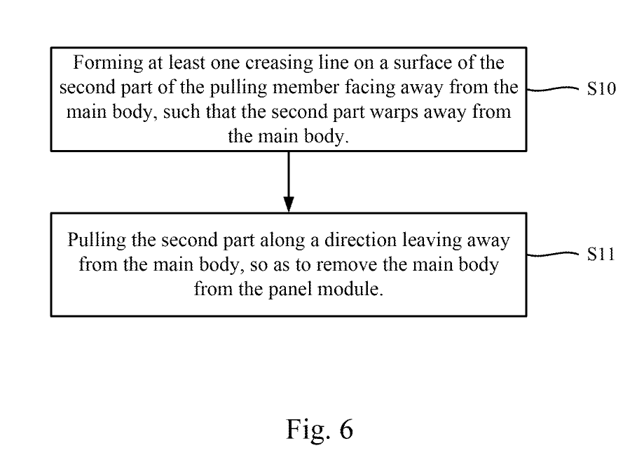

FIG. 6 is flow chart of a method of removing membrane according to an embodiment of the disclosure. As shown in FIG. 6 with references to FIG. 1 and FIG. 2, in the embodiment, the method of removing membrane is used for removing the protective membrane structure 100 from the panel module 200. As described above, the protective membrane structure 100 includes a main body 110, an adhesive member 120, and a pulling member 130. The main body 110 is attached to the panel module 200. The pulling member 130 has a first part (corresponding to the foregoing adhesive portion 131) and a second part (corresponding to the foregoing warping portion 132) connected to each other. The adhesive member 120 is adhered between the main body 110 and the first part. The method of removing membrane of the present embodiment includes steps S10-S11 shown below.

Step S10: forming at least one creasing line 132a on a surface of the second part of the pulling member 130 facing away from the main body 110, such that the second part warps away from the main body 110.

Step 311: pulling the second part along a direction leaving away from the main body 110, so as to remove the main body 110 from the panel module 200.

In an embodiment of the disclosure, the foregoing step S10 can include step S10a: forming a plurality of the creasing lines 132a on the second part along a direction leaving away from the first part.

In an embodiment of the disclosure, the foregoing step S10 can further include step S10b: forming the creasing line 132a by scribing the second part with a blunt object.

In an embodiment of the disclosure, the blunt object can be a blunt knife, but the disclosure is not limited in this regard. In practical applications, any tool capable of forming the creasing line 132a on second part of the pulling member 130 can be applied to the method of removing membrane of the disclosure.

In an embodiment of the disclosure, the method of removing membrane can further include step S12 (referring to FIG. 5) between step S10 and step S11, as shown below.

Step S12: forming at least another creasing line 532b on a surface of the second part facing the main body 110. Therefore, the warpage of the warping portion 532 can be reduced or compensated by the another creasing line 532b located on the lower surface of the pulling member 530, so as to prevent the warping portion 532 from excessive warping.

According to the foregoing recitations of the embodiments of the disclosure, it can be seen that the protective membrane structure of the disclosure and the method of removing membrane are about forming creasing lines on the surface of the pulling member facing away from the main body, so as to make the part of the pulling member not adhered to the main body warp away from the main body. Therefore, the assembly workers can easily hold the warping pulling member, which facilitates the subsequent step of removing the main body away. Furthermore, the protective membrane structure of the disclosure and the method of removing membrane can achieve the purpose of adjusting the warpage of each portion of the warping portion of the pulling member by adjusting the arrangement (e.g., arranged in an equidistant manner, in a gradually closer manner, or in a gradually closer manner) or locations (e.g., on the upper surface or the lower surface of the warping portion) of the creasing lines.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A protective membrane structure configured to protect a panel module, the protective membrane structure comprising:
a main body attached to the panel module;
an adhesive member disposed on the main body; and
a pulling member located over the main body and having an adhesive portion and a warping portion connected to each other, wherein the adhesive member is adhered between the main body and the adhesive portion, and the warping portion warps away from the main body.

2. The protective membrane structure of claim 1, wherein the warping portion has at least one creasing line, and the creasing line is located on a surface of the warping portion facing away from the main body.

3. The protective membrane structure of claim 2, wherein the warping portion has a plurality of creasing lines, and the creasing lines are arranged along a direction leaving away from the adhesive portion.

4. The protective membrane structure of claim 3, wherein the creasing lines are substantially parallel to each other.

5. The protective membrane structure of claim 3, wherein the creasing lines are arranged in a gradually closer manner along the direction leaving away from the adhesive portion.

6. The protective membrane structure of claim 3, wherein the creasing lines are arranged in a gradually farer manner along the direction leaving away from the adhesive portion.

7. The protective membrane structure of claim 2, wherein the warping portion has at least an additional creasing line located on a surface of the warping portion facing the main body.

8. The protective membrane structure of claim 1, wherein the adhesive member is a double-sided adhesive.

9. A method of removing membrane for removing a protective membrane structure from a panel module, the protective membrane structure comprising a main body, an adhesive member, and a pulling member, the main body being attached to the panel module, the pulling member having a first part and a second part connected to each other, the adhesive member being adhered between the main body and the first part, the method comprising:
forming at least one creasing line on a surface of the second part facing away from the main body, such that the second part warps away from the main body; and
pulling the second part along a direction leaving away from the main body, so as to remove the main body from the panel module.

10. The method of claim 9, wherein the forming of the creasing line comprising:
forming a plurality of the creasing lines on the second part along a direction leaving away from the first part.

11. The method of claim 10, wherein the creasing lines are substantially parallel to each other.

12. The method of claim 10, wherein the creasing lines are arranged in a gradually closer manner along the direction leaving away from the first part.

13. The method of claim 10, wherein the creasing lines are arranged in a gradually farer manner along the direction leaving away from the first part.

14. The method of claim 9, wherein the forming of the creasing line comprising:
forming the creasing line by scribing the second part with a blunt object.

15. The method of claim 14, wherein the blunt object is a blunt knife.

16. The method of claim 9, further comprising:
forming at least an additional creasing line on a surface of the second part facing the main body.
